(19) United States
(12) Patent Application Publication
(10) Pub. No.: US 2009/0248293 A1
(43) Pub. Date: Oct. 1, 2009

(54) Vehicle-installed navigation device and program

(75) Inventor: Kenji Nagase, Okazaki (JP)

Correspondence Address: OLIFF & BERRIDGE, PLC, P.O. BOX 320850, ALEXANDRIA, VA, 22320-4850, US

(73) Assignee: AISIN AW CO., LTD., Anjo-shi (JP)

(21) Appl. No.: 12/320,931

(22) Filed: Feb. 9, 2009

(30) Foreign Application Priority Data
Mar. 31, 2008 (JP) 2008-092591
Jan. 26, 2009 (JP) 2009-014221

(51) Int. Cl. G01C 21/36

(52) U.S. Cl. 701/201

(57) ABSTRACT

First, a determination is made as to whether or not an instruction to search for a route again has been issued. When it is determined that an instruction to search for the route again has been issued, a determination is made as to whether or not a destination arrival determination has been made. When a vehicle has reached an arrival road constituting a guidance route within a predetermined range from the destination, it is determined that the destination arrival determination has been made, and the guidance route is searched for again after increasing a road cost that takes into account an advancement direction in relation to the arrival road located in the vicinity of the destination of the set guidance route, whereupon the processing is terminated. As a result, the newly formed guidance route obtained as a result of the new search does not include at least a part of the road constituting the guidance route within the predetermined range from the destination, and therefore, a new guidance route according to which the destination can be reached along a different route to the previous route is obtained.

### INCORPORATION BY REFERENCE

The disclosure of Japanese Patent Application No. 2008-092591 filed on Mar. 31, 2008 including the specification, drawings and abstract is incorporated herein by reference in its entirety.

### BACKGROUND OF THE INVENTION

The present invention relates to a vehicle-installed navigation device.

### DESCRIPTION OF THE RELATED ART

A known navigation device detects a position using GPS or the like, determines an appropriate route from a current location to a destination through calculation, and performs guidance along the route. This type of navigation device is typically provided with a display device such as a color display device, and on a display screen thereof, a current location mark indicating a vehicle position, a map rendered on the basis of map data, and information such as a guidance route indicating the calculated route are displayed in superposed fashion.

Incidentally, road information included in the map data is typically constituted by information relating to links and nodes connecting the links. Furthermore, a cost is set in relation to the links and nodes such that when a route is determined, a route that minimizes the cost, for example, is determined.

In certain cases, however, even when the cost is minimal, the route may not be appropriate due to road conditions and the like.

Hence, a guidance route search-again method for calculating a route by increasing the cost of a road along which a driver does not wish to travel when that road is specified by the driver has recently been proposed (see Japanese Patent Application Publication 2002-286478, for example).

### SUMMARY OF THE INVENTION

However, it is difficult, and undesirable in terms of safety, for the driver to specify a road along which he or she does not wish to travel expeditiously while driving. An example of a case in which the driver wishes to modify the route during travel is when the driver has traveled to the vicinity of the destination but finds it difficult to reach the final destination. For example, when the set destination is located on the right side of the road, the driver must cross over to the opposite lane to reach the final destination, but when the amount of traffic is large or there are no traffic lights, it may be difficult to cross over to the opposite lane. In this case, the driver may wish to modify the route, but since the vehicle is in motion, it is difficult to specify a road.

The present invention has been designed to solve the problem described above, and it is an object thereof to provide a vehicle-installed navigation device with which a different route can be searched for easily when it is difficult to reach a set destination.

A vehicle-installed navigation device according to a first aspect includes: a position detection unit for detecting a current position of a vehicle; a map data storage unit for storing map data; a route search unit for searching for a guidance route, which is a route to a set destination, on the basis of the map data stored in the map data storage unit; and an arrival determination unit for determining whether or not the vehicle has reached a predetermined range from the destination on the basis of the current position of the vehicle detected by the position detection unit, wherein, when a request is issued to search for the guidance route again after the arrival determination unit has determined that the vehicle has reached the predetermined range, the route search unit searches for the guidance route again to obtain a route that does not include at least a part of a road constituting the guidance route within the predetermined range.

In other words, when a search-again request is issued, even when the vehicle has reached the predetermined range from the destination, a new search is performed assuming that the original guidance route is not appropriate. At this time, a new guidance route is searched for in such a manner that the obtained route does not include at least a part of the road that constitutes the guidance route within the predetermined range from the destination. Hence, in cases such as when it is difficult to reach the set destination, another route can be searched for easily. Note that the search-again request may be issued on the basis of an instruction from the driver or may be generated automatically when the vehicle deviates from the guidance route.

When a different route that does not include at least a part of the road that constitutes the guidance route within the predetermined range from the destination is determined as a result of a new search in the manner described above, the following constitutions may be employed.

According to a second aspect, the new guidance route is searched for by modifying an evaluation value relating to the road constituting the guidance route within the predetermined range from the destination, and therefore, a route that does not include at least a part of this road can be searched for easily.

This will now be described more specifically.

According to a third aspect, when the road constituting the guidance route within the predetermined range from the destination is a direct route, the new guidance route is searched for by modifying an evaluation value relating to an advancement direction along the direct route. Here, the advancement direction includes a forward direction matching the direction set on the original route and an opposite direction that does not match the direction set on the route. Hence, when the original guidance route within the predetermined range from the destination is set in the forward direction, a new search is performed by modifying the evaluation value of the forward direction. Thus, when the guidance route within the predetermined range from the destination is set in the forward direction, the route following the new search is likely to be set in the opposite direction, and when the route following the new search is set in the opposite direction, a destination positioned on the right side of the guidance route switches to the left side following the new search, for example. As a result, an appropriate new route can be found.

This will now be described more specifically.

According to a fourth aspect, when a right/left turning point is included on the road constituting the guidance route within the predetermined range from the destination, the new guidance route is searched for by modifying an evaluation value relating to a right/left turn at the right/left turning point. Here, the phrase “when a right/left turning point is included” includes a case in which a right turn is included, a case in which a left turn is included, and a case in which both are included. For example, a right turn may be included in the original guidance route within the predetermined range from the destination. In this case, a new search is performed after modifying the evaluation value of the right turn. Thus, when a right turn (left turn) is included in the guidance route, a left turn (right turn) from the opposing lane is likely to be included in the route following the new search. As a result, an appropriate new route can be found.

An invention relating to a vehicle-installed navigation device was described above, but a feature of the present invention relates to search-again processing, and therefore the present invention may also be realized as a program such as the following.

A program according to a fifth aspect includes: route search processing for searching for a guidance route, which is a route to a set destination, on the basis of map data stored in a map data storage unit; arrival determination processing for determining whether or not a vehicle has reached a predetermined range from the destination on the guidance route on the basis of a current position of the vehicle detected by a position detection unit; and search-again processing for searching for the guidance route again when a request is issued to search for the guidance route again after the vehicle is determined to have reached the predetermined range in the arrival determination processing in order to obtain a route that does not include at least a part of a road constituting the guidance route within the predetermined range.

Note that in this type of program, the respective processes may be modified such that the functions of the vehicle-installed navigation device according to any of the second to fourth aspects described above are exhibited.

### BRIEF DESCRIPTION OF THE DRAWINGS

FIG. 1 is a block diagram showing the constitution of a vehicle-installed navigation device according to an embodiment of the present invention;

FIG. 2 is a flowchart showing an outline of a navigation function of the vehicle-installed navigation device;

FIG. 3 is a flowchart showing search-again processing according to an embodiment of the present invention;

FIG. 4 is an illustrative view showing an example of the search-again processing according to an embodiment of the present invention; and

FIG. 5 is an illustrative view showing an example of the search-again processing according to an embodiment of the present invention.

### DETAILED DESCRIPTION OF THE EMBODIMENTS

An embodiment of the present invention will be described below on the basis of the drawings.

### First Embodiment

An embodiment to which the present invention is applied will now be described using the drawings.

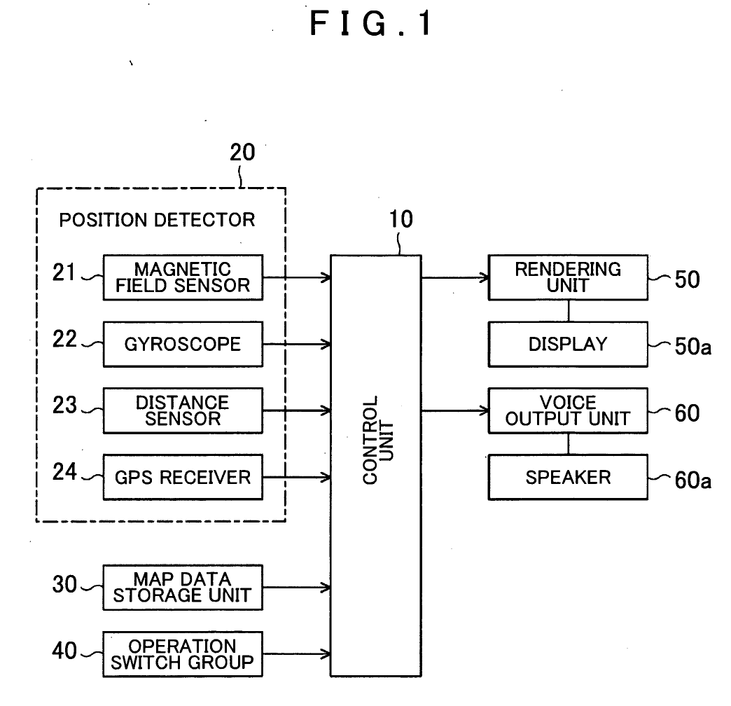

FIG. 1 is a block diagram showing the overall constitution of a vehicle-installed navigation device 1 serving as the embodiment. The vehicle-installed navigation device 1 is constituted around a control unit 10 and includes a position detector 20, a map data storage unit 30, an operation switch group 40, a rendering unit 50, and a voice output unit 60, all of which are connected to the control unit 10. Note that the control unit 10 is constituted by a normal computer including a CPU, a ROM, a RAM, an I/O, a bus line connecting these components, and so on. Further, a display 50a is electrically connected to the rendering unit 50 and a speaker 60a is electrically connected to the voice output unit 60.

The position detector 20 includes a magnetic field sensor 21, a gyroscope 22, a distance sensor 23, and a GPS (Global Positioning System) receiver 24 for detecting a vehicle position on the basis of radio waves from a satellite, all of which are well known. These sensors 21 to 24 and so on respectively possess different property errors, and are therefore interpolated to each other for use. Depending on the required degree of precision, the position detector 20 may be constituted by a part of these components, or may further include a steering wheel rotation sensor, a wheel sensor provided for each drive wheel, and so on. The map data storage unit 30 stores so-called map matching data for improving the precision of position detection, and map data. Specifically, the map data storage unit 30 may be constituted by a hard disk device (HDD). Note that although an HDD is used in this embodiment, another medium such as a DVD-ROM or a memory card may be used instead.

The operation switch group 40 is constituted by touch switches or mechanical switches formed integrally with the display 50a, a remote control device, or similar, and is used to perform various types of input. As noted above, the display 50a is connected to the rendering unit 50. The display 50a is a color display employing liquid crystal or CRT. Information display is performed via the display 50a. The speaker 60a is connected to the voice output unit 60, and voice guidance is performed through the speaker 60a.

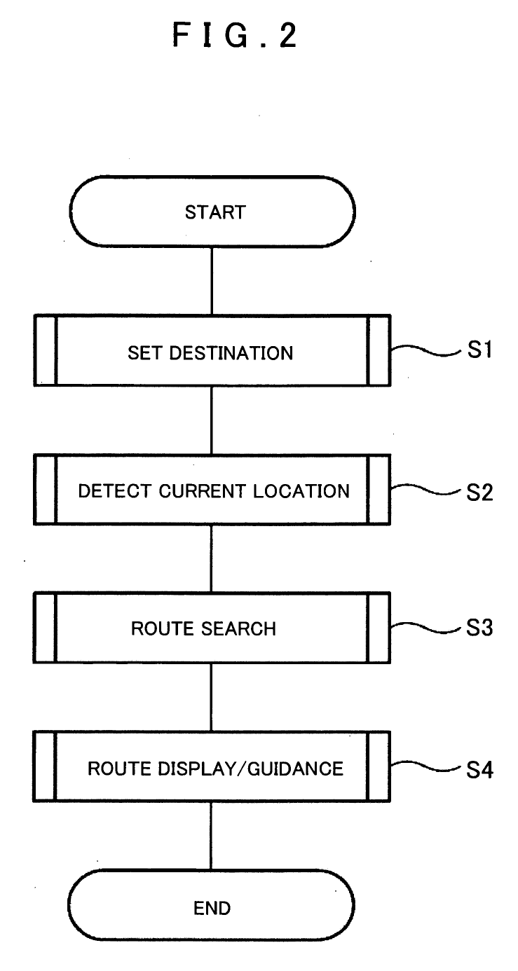

Next, a navigation function will be described on the basis of the flowchart shown in FIG. 2.

First, in a step S1 (hereafter, “step” will be omitted and the symbol “S” will be used alone), destination search and setting is performed. In this processing, the driver sets a destination on the vehicle-installed navigation device 1 via the operation switch group 40. To search for a destination, for example, conditions such as the name, address, or telephone number of the destination are input and a list of destinations corresponding to these conditions is displayed on the display 50a. The driver then makes a selection from the list to set the destination. More specifically, when the driver makes a selection from the list, a map on which the selected point forms the center of a cursor is displayed, and when the driver touches a “set” button, the point is set as the destination.

Next, in S2, the current position of the vehicle is detected. This processing is performed on the basis of information input from the position detector 20. When the current position has been detected and route guidance is to be performed from the current position, the current position is confirmed as a starting point. The detected current position is indicated by displaying a current vehicle location mark on the map.

Next, in S3, a route search is performed. In this processing, an optimum route from the current location to the destination is selected automatically to form a so-called guidance route. The optimum route is searched for using a method such as the Dijkstra method.

Next, in S4, route guidance and display are performed. In this processing, the formed guidance route is displayed on the display 50a, and a guidance voice focusing mainly on route guidance is output through the speaker 60a by the control unit 10 in accordance with the vehicle traveling conditions.

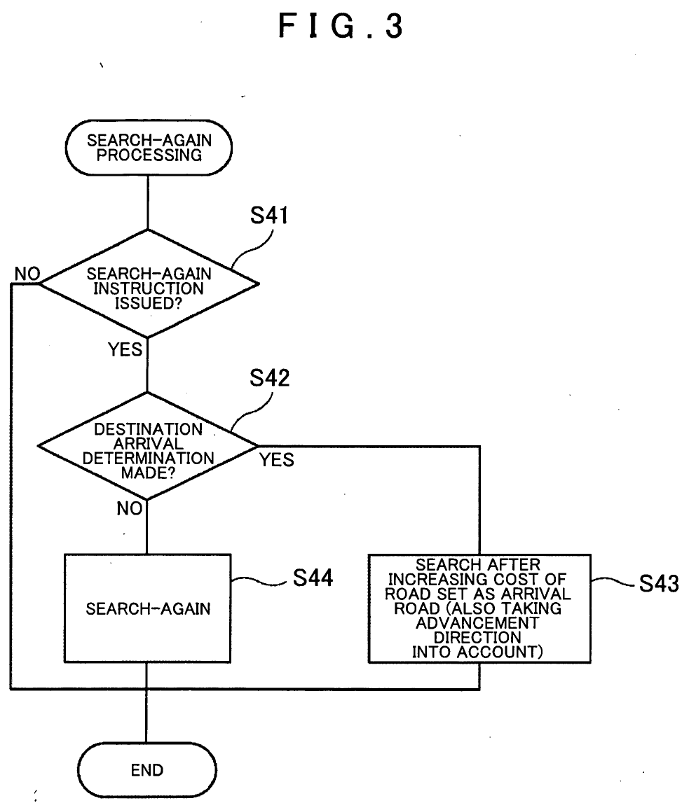

The route guidance and display performed in S4 continue until the destination is reached. However, S4 may include so-called “search-again processing” in which the route search is performed again in accordance with variation in the vehicle traveling conditions, road conditions, and so on, or in accordance with the will of the driver. Search-again processing according to this embodiment will be described below on the basis of FIG. 3.

FIG. 3 is a flowchart showing the search-again processing. First, in S41, a determination is made as to whether or not a search-again instruction has been issued. When it is determined that a search-again instruction has been issued (S41: YES), the routine advances to S42. When a search-again instruction has not been issued (S41: NO), the search-again processing is terminated.

In S42, a determination is made as to whether or not a destination arrival determination has been made. In this processing, a determination is made as to whether or not an arrival determination unit determined that “an arrival road to the destination was reached” before the point at which the routine advanced from S41 to S42. Here, the arrival road corresponds to a road constituting the guidance route within a predetermined range from the destination. When it is determined at this time that a destination arrival determination has been made (S42: YES), the routine advances to S43. When it is determined that a destination arrival determination has not been made (S42: NO), the routine advances to S44.

In S43, a route search is performed after increasing the cost (evaluation value) of the road set as the arrival road. In this processing, a guidance route is searched for anew after increasing a road cost of at least a part of a road constituting the initially set guidance route within a predetermined range from the destination after taking an advancement direction in relation to the guidance route into account, thereby forming the newly formed guidance route obtained as a result of the new search that does not include at least a part of the road constituting the guidance route within a predetermined range from the destination. After performing the search in S43, the search-again processing is terminated.

In S44, on the other hand, search-again is performed normally. In this processing, a new guidance route is formed by selecting an optimum route from the current location to the destination on the basis of the currently set search conditions and traffic information received by a communication instrument, not shown in the drawings, regardless of the initially set guidance route. After performing the new search in S44, the search-again processing is terminated.

To facilitate understanding of the search-again processing described above, a specific example thereof will be described below.

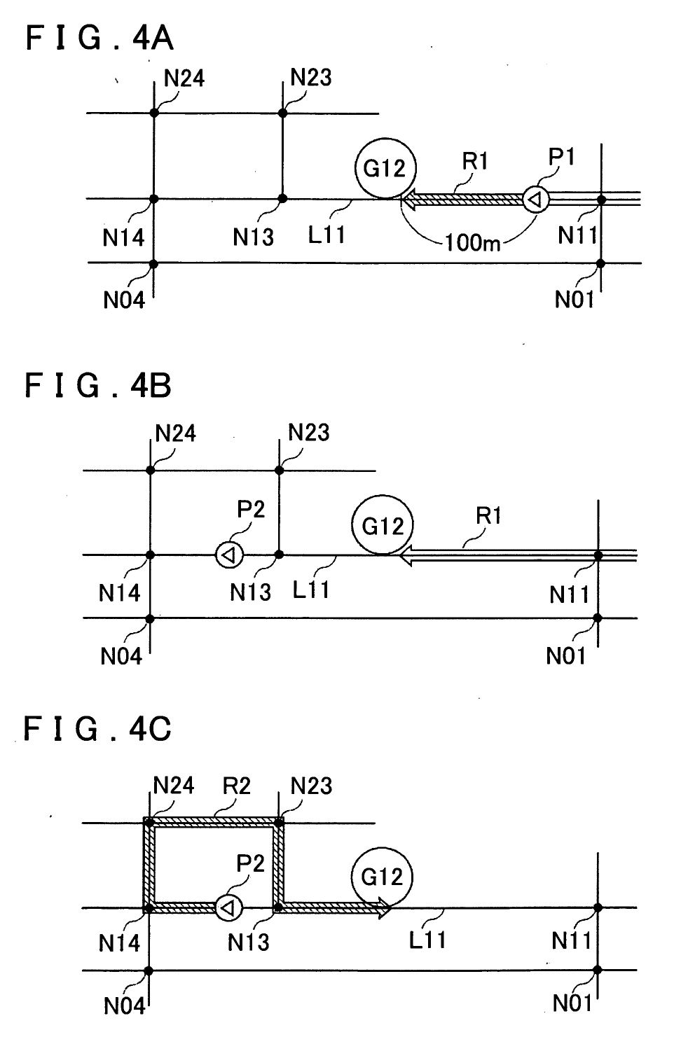

Here, an example of the destination arrival determination processing will be described using FIG. 4A. In this drawing, N denotes a node and L denotes a link. According to FIG. 4A, L11 linking N11 and N13 corresponds to the link including the arrival road. Further, a direction heading from N11 to N13 is the forward direction. Further, a route extending from a starting point, not shown in the drawing, to a destination G12 via N11 serves as an initially set guidance route R1. A destination arrival determination is performed by the control unit 10 when the vehicle position reaches a point within a predetermined range (100 m) from the destination G12 on the road leading to the destination G12. At this point, the control unit 10 detects that the vehicle has arrived within the vicinity of the destination and outputs voice guidance indicating arrival at the destination through the speaker 60a. Note that according to this embodiment, processing in which the control unit 10 determines that the vicinity of the destination has been reached on the basis of the position detector 20 and the map data storage unit 30 corresponds to a function of the arrival determination unit.

Here, a case in which search-again processing is performed at a current location P2 shown in FIG. 4B will be described. First, a determination is made as to whether or not a search-again instruction has been issued (S41 in FIG. 3). The search-again instruction is issued by the driver or issued automatically by the vehicle-installed navigation device 1. For example, a search-again instruction is issued when the driver selects a “search-again” button via the operation switch group 40. Alternatively, a search-again instruction is issued automatically when the current location P2 is detected to have deviated from the initially set guidance route R1, as shown in FIG. 4B.

When it is determined that a search-again instruction has been issued (S41: YES in FIG. 3), a determination is made as to whether or not a destination arrival determination has been made (S42 in FIG. 3). In this embodiment, a case in which the destination arrival determination is made at a time when the vehicle passes a point P1 in FIG. 4A before reaching the current location P2 in FIG. 4B will be described.

When it is determined that the destination arrival determination has been made (S42: YES in FIG. 3), a search is performed after increasing the cost of the link including the arrival road (S43 in FIG. 3). The road cost is modified taking the advancement direction into account. In other words, a search is performed after increasing the cost of the link including the arrival road in relation to the advancement direction. Here, in a case where there are a plurality of links including the arrival road, the costs of all the links including the arrival road may be increased. Or, only the cost of a specific link (e.g., the link closest to the destination, the link second-closest to the destination) may be increased.

Here, the “cost of the link including the arrival road” is a set link cost, i.e. a load expended while traveling along a road in the advancement direction, which is provided for the links that connect the nodes disposed at intersections on the map data stored in the map data storage unit 30 and set in relation to the advancement direction from a node at one end of a link to a node at the other end of the link.

For example, when the forward direction link cost of L11 is increased by 2 km and a new guidance route to the destination G12 is searched for, the road extending from N11 to N13 may be considered as a road that corresponds to a traveling distance obtained by adding 2 km to the distance from N11 to N13.

In the state shown in FIG. 4B, when a new guidance route is searched for after increasing the forward direction link cost of L11 including the arrival road (S43 in FIG. 3), an optimum route from the current location P2 to the destination G12, for example a route having a minimum total road cost after taking the advancement direction in relation to the road into account, is selected to form a new guidance route.

Route selection in this case will now be described. According to FIGS. 4B and 4C, the arrival road of the guidance route from an arbitrary starting point to the destination G12 corresponds to either the road that leads to the destination G12 from an intersection N11 or the road that leads to the destination G12 from an intersection N13 on the road linking N11 and N13. As described above, the cost of the road that leads to the destination G12 from N11 corresponds to the forward direction link cost of L11, and since this road includes the arrival road of the initially set guidance route, a large cost is added thereto. On the other hand, the cost of the road leading to the destination G12 from N13 corresponds to the opposite direction link cost of L11, and is therefore likely to be smaller than the forward direction link cost of L11.

Hence, the road leading to the destination G12 included in the new guidance route formed by the guidance route search-again processing of S43 is likely to be the road leading to the destination G12 from N13, as shown in FIG. 4C. This new guidance route is a route R2 leading to the destination G12 from the current location P2 via N14, N24, N23, and N13, for example. Hence, according to S43, the new guidance route R2 not including the arrival road of the pre-search-again guidance route R1, is searched for easily and automatically.

According to the vehicle-installed navigation device 1 of this embodiment, when route modification is required for a reason such as that described in the above example, a situation in which the vehicle is repeatedly guided to a road that cannot be entered after searching for a new guidance route can be prevented. As a result, a different route can be searched for easily in cases where is it difficult to reach the set destination or the like.

In the specific example of the search-again processing described in detail above, a case in which the guidance route within a predetermined range from the destination is a direct route was described, but according to this embodiment, a search may be performed taking right and left turns at right and left turning points into account when right and left turning points are included in the guidance route within a predetermined range from the destination (S43 in FIG. 3).

Here, a specific example of a case in which right and left turning points are included in the guidance route within the predetermined range from the destination will be described.

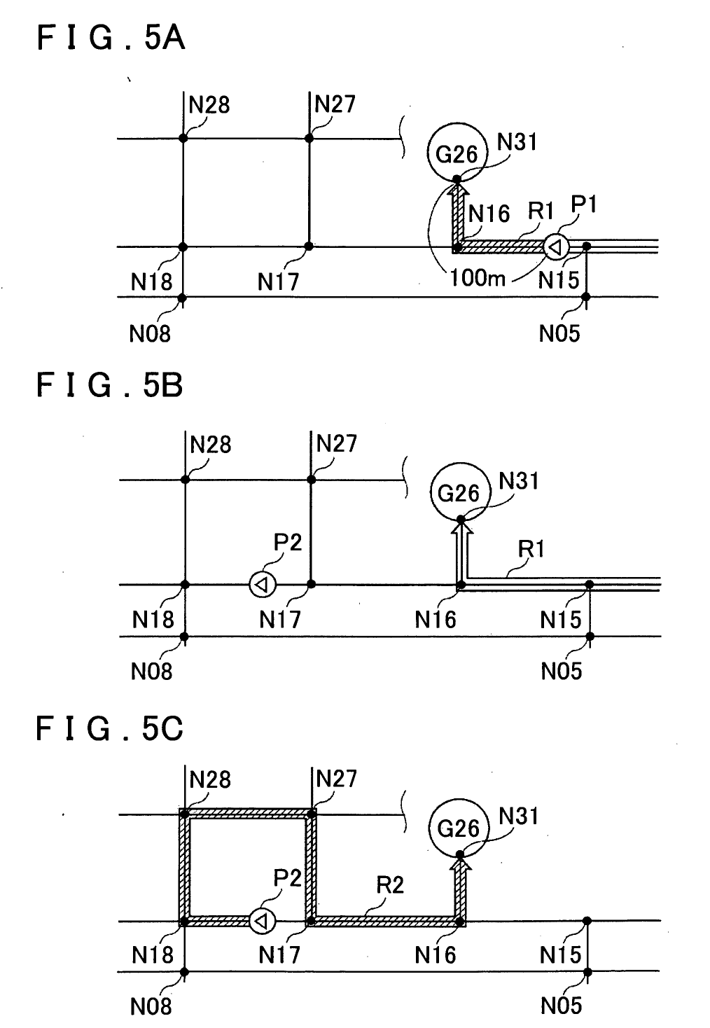

According to FIG. 5A, the guidance route within the predetermined range (100 m) of the destination is constituted by a road extending from a current location P1 to N31 via N16, which is a right turning point. When a search-again instruction is issued at the current location P2 in FIG. 5B, the right turn cost of the right turn point N16 is increased. For example, 2 km is added thereto. As a result, a new guidance route R2 does not include a right turn at N16, or in other words, the new guidance route R2 includes a left turn, as shown in FIG. 5C. Hence, when a right turn is included in the original guidance route within the predetermined range from the destination, a left turn rather than a right turn can be included in the guidance route following the new search.

The present invention is not limited to the embodiment described above, and may be implemented in various embodiments within a range that does not depart from the spirit of the invention.

What is claimed is:

1. A vehicle-installed navigation device comprising:
a position detection unit for detecting a current position of a vehicle;
a map data storage unit for storing map data;
a route search unit for searching for a guidance route, which is a route to a set destination, on the basis of the map data stored in the map data storage unit; and
an arrival determination unit for determining whether or not the vehicle has reached a predetermined range from the destination on the basis of the current position of the vehicle detected by the position detection unit, wherein,
when a request is issued to search for the guidance route again after the arrival determination unit has determined that the vehicle has reached the predetermined range, the route search unit searches for the guidance route again to obtain a route that does not include at least a part of a road constituting the guidance route within the predetermined range.

2. The vehicle-installed navigation device according to claim 1, wherein
the route search unit searches for the guidance route again by modifying an evaluation value relating to the road constituting the guidance route within the predetermined range.

3. The vehicle-installed navigation device according to claim 2, wherein,
when the guidance route within the predetermined range is a direct route, the route search unit searches for the guidance route again by modifying an evaluation value relating to an advancement direction along the road constituting the guidance route within the predetermined range.

4. The vehicle-installed navigation device according to claim 3, wherein,
when a right/left turning point is included in the guidance route within the predetermined range, the route search unit searches for the guidance route again by modifying an evaluation value relating to a right/left turn at the right/left turning point.

5. The vehicle-installed navigation device according to claim 2, wherein, when a right/left turning point is included in the guidance route within the predetermined range, the route search unit searches for the guidance route again by modifying an evaluation value relating to a right/left turn at the right/left turning point.

6. A program comprising:
route search processing for searching for a guidance route, which is a route to a set destination, on the basis of map data stored in a map data storage unit;
arrival determination processing for determining whether or not a vehicle has reached a predetermined range from the destination on the guidance route on the basis of a current position of the vehicle detected by a position detection unit; and
search-again processing for searching for the guidance route again when a request is issued to search for the guidance route again after the vehicle is determined to have reached the predetermined range in the arrival determination processing in order to obtain a route that does not include at least a part of a road constituting the guidance route within the predetermined range.
